(19) United States
(12) Patent Application Publication
(10) Pub. No.: US 2002/0002053 A1
(43) Pub. Date: Jan. 3, 2002

(54) Method for geo-location interpolation and compression

(76) Inventors: Ki Y. Nam, Newport Beach, CA (US); Gallin C. Chen, Huntington Beach, CA (US); William J. Northrup, Oceanside, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/894,344

(22) Filed: Jun. 28, 2001

Related U.S. Application Data
(60) Provisional application No. 60/215,740, filed on Jun. 29, 2000.

(51) Int. Cl. H04Q 7/20

(52) U.S. Cl. 455/456; 342/357.11

(57) ABSTRACT

A system and method for efficiently transmitting geographical location data of mobile units is disclosed. The invention allows less than the complete geographical location data to be transmitted and reported to a locater. Using fixed geographical references, the locater then interpolates the complete geographical location of mobile units from the reported data.

### FIELD

The invention relates to a locating system and more particularly, to a geographic position communication system that allows a transmission of compressed geographic position data.

### BACKGROUND

Determining the geographical positions of mobile units has recently become important for a wide range of applications. For example, a locater can be used to locate a stolen car, to provide security in transport of objects and to provide direction services through which the location of, for example, the nearest gas station, restaurant, or hospital can be determined. In cellular telephones, determining the geographical position may help subscribers in events such as a car failure, accident or crime.

While the cellular telephone can facilitate voice communication in these situations, the subscriber must first have knowledge of the subscriber's location. Accordingly, many techniques are being considered and developed to provide automatic location capability. The geographical location (hereinafter “geo-location”) of a mobile unit can then be transmitted to a locater for application.

However, in many applications, the cost for transmitting data depends on the amount of data passed. Therefore, transmitting the geo-location data using a limited data payload can reduce costs.

### BRIEF SUMMARY OF THE INVENTION

The method and system allows a transmission of compressed geographical location data of mobile units to reduce the amount of data payload. Using a plurality of references, each having a reference positional data, a locater receives a compressed positional data of a mobile unit and determines the geographic position of the mobile unit. In one embodiment, the locater determines the geographic position by comparing the compressed position data against a reference positional data.

Also, the method and system of transmitting compressed geographical location may be implemented into an existing system or references. For example, in one embodiment, a cellular network is used in transmitting the compressed geographical location data. In one embodiment, the geographical location of a mobile is determined using the Global Position System technology.

### BRIEF DESCRIPTION OF THE DRAWINGS

The invention will be described in detail with reference to the following drawings in which like reference numerals refer to like elements wherein:

FIG. 1 illustrates a geographical location communicating system in accordance to the invention;

FIG. 2 illustrates a cellular network in accordance to the invention;

FIG. 3 illustrates a roaming mobile unit in a cellular network in accordance to the invention; and

FIG. 4 illustrates a geographical location interpolation procedure in accordance to one embodiment of the invention.

### DETAILED DESCRIPTION

In the following description, specific details are given to provide a thorough understanding of the invention. For example, some circuits are shown in block diagram in order not to obscure the present invention in unnecessary detail. However, it will be understood by those skilled in the art that the present invention may be practiced without such specific details.

As disclosed herein, the term “mobile unit” refers to any remote device such as a cellular phone, cellular telephone equipment, or a beacon. The term “mobile asset” refers to any object capable of movement, such as a motor vehicle, a boat, or a bicycle. The term “transmission” refers to sending data over a communication line, and may include both wired and wireless transmission. The term “locater” refers to any positioning server including, but not limited to an Application Service Provider (ASP). Also, the term “geographical position” and “geographical location” will be used interchangeably.

Generally, transmission of less than the complete geographical position (“geo-location”) data of mobile units is achieved using a set of references. Here, a set of references already existing independently can be used to implement the invention. By referring to the geographical location of a reference, the complete geo-location of mobile units can be recovered from transmissions of a compressed or reduced geo-location data. Reducing the geo-location data of mobile units saves space and/or fits the positional data within an allowed size of a transmitted data payload, sometimes referred to as a single data packet.

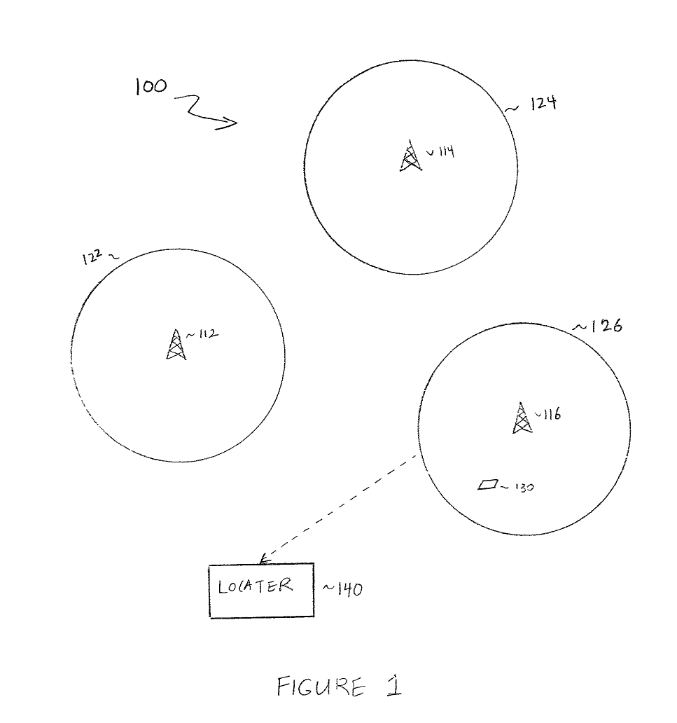

FIG. 1 shows an exemplary embodiment of a geo-location communication system 100 in accordance with the invention including a plurality of references 112˜116, each respectively covering a region 122˜126. Although the regions 122˜126 are shown to cover an area in the shape of circles, the regions 122˜126 may be in any shape including but not limited to a square, a rectangle and a hexagon. Also, the references 112˜116 are stationary with fixed geo-locations to be determined and set as reference positional data.

A locator 140 receives a compressed geo-location data of a mobile unit 130 and a reference data corresponding to the reference 116 covering the region 126 which contains the mobile unit 130. The compressed geo-location data may be sent to the locator 140 by a wireless or wired transmission. The reference data corresponding to the reference 116 may also be sent by a wireless or wired transmission.

In one embodiment, the reference data may be an assigned identification (ID) code of the reference 116. For example, a unique ID code can be assigned to each reference 112˜116 and stored with the corresponding reference positional data at the locater 140. Since the reference positional data for each reference may be predetermined, when a locater 140 receives an ID code with the compressed geo-location data of a mobile unit 130, the reference positional data can be obtained using the ID code. In another embodiment, the reference data may be the reference positional data of a reference, in which case the reference positional data need not be stored at the locater 140. In such case, the reference positional data may also be predetermined and stored at each corresponding references. Moreover, in some applications, as will be discussed in more detail below, the reference data may be a parameter that is automatically transmitted within a system as part of the normal operations.

When the reference positional data of the reference 116 is obtained using the received reference data, the locator 140 recovers the complete geo-location data of the mobile unit 130 using the received compressed geo-location data. The particular methods to recover the complete geo-location data vary based upon the method used to compress the geo-location data. Namely, there may be many ways to compress the geo-location data of a mobile unit in accordance with the invention, one of which is to compress the geo-location data of a mobile unit by truncation based upon the differences in positions among the references.

Generally, if the positional difference between two references is approximately x number of digits, the geo-location of a mobile unit needs to be determined to the nearest x number of digits. The rest can be recovered from the reference positional data. Accordingly, the digits left of x number of digit(s) may be truncated in the geo-location data of the mobile unit. For example, assume that a reference positional data of the reference 112 in FIG. 1 is 165 in measured units, a reference positional data of the reference 116 is 173 units, and a geo-location data of the mobile unit 130 is 171. Since the positional difference between the references 112 and 116 is 8 units, the digits left of the least significant digit can be truncated. Therefore, the least significant digit of “1” is the compressed geo-location data of the mobile unit 130 and is transmitted to the locater 140. Thereafter, the complete geo-location data of the mobile unit can be recovered using the reference data.

As there may be many ways to compress the geo-location data of a mobile unit, there may also be more than one method to recover the complete geo-location data from the geo-location data compressed by truncation. In one embodiment, an iterative comparison is used to interpolate and recover the complete geo-location of mobile units. The comparison is between the truncated geo-location data of a mobile unit and the reference positional data corresponding to the reference data received. In the given example, the reference data corresponding to the reference 116 would be received since the mobile station 130 is within the region 126 covered by the reference 116. Accordingly, the least significant digit “3” of the reference positional data 173 is compared with the truncated geo-location data of “1.”

In the comparison, if there is no match, the value of the reference positional data is adjusted and re-compared with the truncated geo-location data of “1” until a match is found. In one embodiment, the reference positional data is adjusted as follows, in which the reference positional data is incremented and decremented by a predetermined unit.

Assuming a predetermined unit of “1,” a unit of “1” is added to the reference positional data and the resulting least significant digit “4” of 174 is compared with the truncated data of “1.” No match. Subtracting “1” unit, the least significant digit “2” of 172 is compared with “1.” No match. Adding “2” units, the least significant digit “5” of 175 is compared with “1.” No match. Finally, subtracting “2” units, the least significant digit “1” of 171 is compared with “1” and a match is found.

The geo-location of the mobile unit 130 is then determined as 171 units.

Although the system and method of locating a mobile unit as described above generates a fairly efficient and accurate result, an error checking procedure may further be implemented to improve the accuracy of the determined geo-location. In one embodiment, the error checking procedure checks the geo-location of a mobile unit to determine if the interpolated geo-location of the mobile unit falls within the boundary of the region covered by the reference corresponding to the reference data received. Continuing with the example above, the interpolated geo-location of the mobile unit 130, i.e. 171 units, is checked to determine if it falls within the boundary of the region 126 covered by the reference 116. Since the area of the region covered by each reference can be approximated, the boundary of each region may be predetermined. In determining the boundary, the area of each region can be overestimated or underestimated to achieve a lower or higher confidence level for the error-checking procedure.

By reducing the amount of information that is transmitted to a locater, the invention can be integrated in a wide variety of systems and applications that require a transmission of geo-location data using a limited data payload.

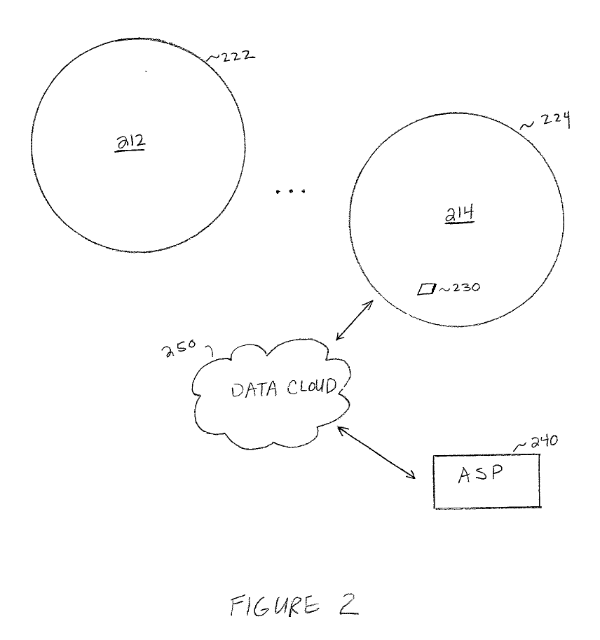

FIG. 2 shows one of many possible implementations of the invention, in which a cellular network 200 is used to transmit the compressed geo-location data of mobile units. The cellular network 200 includes a plurality of cellular systems 212˜214, each having an assigned system identification (SID) code and each respectively covering a region 222˜224. Generally, a cellular system in which a mobile unit is registered is the home system of the mobile unit. When a mobile unit is activated, the SID of the system in which the mobile unit is operating is broadcasted as part of the normal operations in order to service the mobile unit. If the mobile unit is operating outside of its home system, the mobile unit is said to be “roaming.”

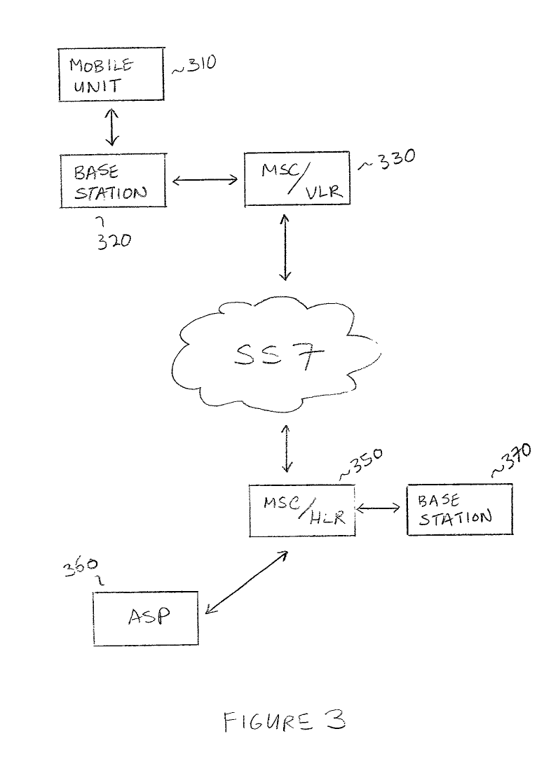

FIG. 3 shows an example of a roaming mobile unit 310 in the cellular network 200. Messages from the mobile unit 310 are received by a base station 320 and processed by a visiting location register (VLR) of a mobile switch center (MSC) 330. The VLR 330 forwards a data payload, including an Electronic Serial Number (ESN) of the mobile unit 310, the SID and the compressed geo-location data, to a home location register (HLR) of a MSC 350 through Signaling System 7. Here, the ESN is a code assigned to uniquely identify the mobile unit 310. The HLR 350 processes and re-transmits the data to an ASP 360 to provide the service required by the mobile unit 310. Note, that if a mobile unit were operating within its home system, the SID would be known. Hence, the ESN and the compressed geo-location data may be transmitted to the HLR 350 through a base station 370. FIG. 3 is an exemplary application of system and method to transmit compressed geo-location data using one base station and one mobile unit, various combinations of base stations and mobile units may be used without departing from the spirit and scope of the invention.

Referring back to FIG. 2, if a mobile unit 230 is activated, the SID of the system 214 and the compressed geo-location data of the mobile unit 230 would be received by an ASP 240 through a data cloud 250 as described above. Moreover, the geo-location for each SID is stored at the ASP 240 as part of the system operation. Accordingly, the SID is used as the reference data and the ASP 240 can extract the geo-location data associated with the SID to be used as the reference positional data. The ASP 240 can then determine the complete geo-location data of the mobile unit 230 from the geo-location data using the reference positional data.

By using the SID as the reference data, additional data for use as the reference data need not be sent in the data payload for determining the geo-location of a mobile unit. Therefore, the reference data need not be sent in the data payload. Moreover, in cellular systems, the data payload is transmitted through different channels. Control channels are used to initiate a call and a voice channel is used after a call is initiated. Although any channel can be used, in one embodiment, the data payload including the compressed geo-location data is transmitted as part of the overhead using a control channel. The compressed geo-location data may also be transmitted within the ESN or within the digits dialed by a mobile unit. While the above cellular system has been described using the SID as the references, other information can be used as such as a cell cite within a cellular system or the point code of equipments such as the HLR, the VLR or the MSC that transports the data.

Furthermore, one of many ways by which a mobile unit can determine its geo-location is by using the Global Positioning System (GPS) technique. GPS is a constellation of 24 satellites that makes it possible for GPS receivers to determine their geographic location. Generally, each satellite continually broadcasts its changing position and time and a GPS receiver triangulates its geographic location by receiving bearings from three satellites. The result is provided in units of latitude and longitude. Using a fourth satellite, the receiver can also determine altitude as well as the geographic position.

In one embodiment which implements the GPS in the cellular network 200 above, a mobile unit is a GPS receiver and obtains its geo-location data from the GPS in units of latitude and longitude. The latitude and longitude reported by the mobile unit each contains 1 digit of the degree portion. For instance, if the latitude is 23 degrees, the second 3 will be reported and if the longitude is—117, the 7 will be reported. Digits representing the minutes of the latitude and longitude are completely reported. Thus, the ASP 360 of FIG. 3 determines the most significant digit of the latitude and the 2 most significant digits of the longitude. These can be determined because the SID is also contained in the data the ASP 360 receives from the HLR 350. Based on how finite and precise the reference is, the less or more digits can sometimes be interpolated.

For example, the difference in latitude across regions typically covered by a cellular system in the United States is approximately 2 degrees. Therefore, the ASP need to determine the latitude to the nearest 10 degrees. The rest is recovered through the SID or the reference. This is the same for the longitude.

Accordingly, when a message comes in, the ASP starts with the latitude and the longitude of the reported SID, namely the reference positional data. The reported latitude, i.e. the truncated geo-location data, is checked against the least significant degree digit (LSDD) of the reference positional data. If the digits match, the reference's more significant digits are the same as the mobile unit's. Otherwise, the LSDD of the reference positional data is incremented and/or decremented in units of 1 degree until a match is found. The same process is repeated for the longitude.

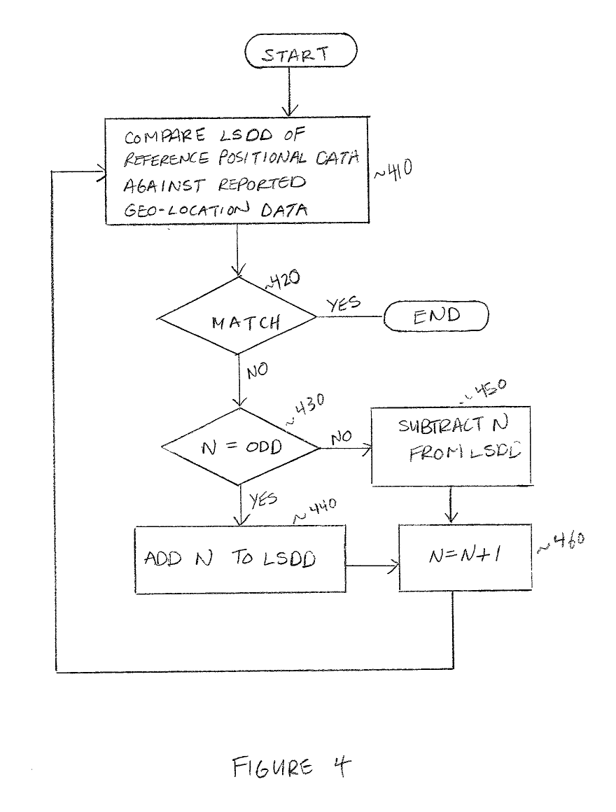

FIG. 4 shows one embodiment of the interpolation procedure 400 to determine the geo-location data of a mobile unit. The LSDD of the reference positional data is checked against the reported geo-location data (block 410). If there is no match, a determination is made whether the increment/decrement unit of N is odd (blocks 420 and 430). The value of N is initially set 1. If N is odd, N is added to the LSDD (block 440). Otherwise, N is subtracted from the LSDD (block 450). Thereafter, the value of N is increased by 1 (block 460) and the LSDD is checked against the reported geo-location data (block 410). If there is a match, the process ends. The more significant degree digits of the reference positional data are determined to be the same as the mobile unit's.

For example, assume an approximate location for SID number 00488 in Provo, Utah is 40 degrees 13.66 minutes North latitude and 111 degrees 39.12 minutes West longitude. A mobile unit roughly 20 miles south of Provo on Interstate 15 would report something like 9 degrees 58.30 minutes latitude and 1 degree 48.00 minutes longitude. Looking first at the longitude, the reported 1 degree matches the third 1 in 111 degrees. The ASP would then determine that the mobile unit's longitude is 111 degrees 48 minutes West. Turning to the reference latitude of 40 degrees, 0 does not equal 9. Therefore, adding a value of 1 to the reference latitude yields 41 degrees. Since 1 does not equal 9, a value of 1 is subtracted from the original reference latitude yielding 39 degrees. Here, the LSDD of the reference latitude matches 9 and the latitude of the mobile unit is determined as 39 degrees 58.30 minutes North.

In the interpolation procedure 400, the LSDD can first be decremented and then incremented to be compared against the reported geo-location data. Alternatively, the LSDD can simultaneously be incremented and also decremented, in which case an incremented LSDD and a decremented LSDD would be compared against the reported geo-location data. Furthermore, if an error checking procedure has been implemented, the ASP would check whether the mobile unit falls within the region covered by the SID number 00488.

As described above, reduced geo-location data of mobile units can be transmitted to a locater and recovered using reference positional data. Moreover, the system and method for transmitting the reduced geo-location data can easily be implemented using a system of references already existing, such as the cellular network. Therefore, the geo-location communication system and method in accordance with the invention can be applied in a wide range of application.

A tracking and communication device is one application in which the present invention can be implemented. A mobile unit can be installed in a mobile asset such as an automobile to track the vehicle's location using, for example, the GPS technology. When polled by a user, the vehicle's location may be reported using mobile unit in the form of compressed geo-location data. Here, the cellular network can be used, as described above. For example, the mobile unit reports its geo-location when a driver activates a signal to notify a service center that the driver needs roadside assistance. Also, an alarm system can monitor the vehicle's alarm system to notify a service center that the alarm has been activated and to give the geo-location. In still another embodiment, the mobile unit can actively broadcast its geo-location in predetermined intervals without being polled by a user.

While several examples uses and implementation of the invention have been described, it will be understood by one of ordinary skill in the art that the invention is not limited to these uses. For example, the present invention can be used for locating the position of mobile units in air and/or sea. Therefore, the foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A geographical location communication system comprising:
a plurality of references, each having reference positional data;
a mobile unit within a region covered by a reference, the mobile unit capable of determining the geographical location (geo-location) of the mobile unit; and
a locator to receive compressed geo-location data of the mobile unit and to determine the geo-location of the mobile unit by comparing the compressed geo-location data against the reference positional data of the reference covering said region.

2. A system of claim 1, wherein the mobile unit determines the geo-location using a Global Position System.

3. A system of claim 1, wherein the compressed geo-location data is in units of latitude and longitude.

4. A system of claim 3, wherein the compressed geo-location data includes at most one least significant degree digit of the latitude and at most two least significant degree digits of the longitude.

5. A system of claim 4, wherein the locator determines the most significant degree digit of the latitude and at least the most significant degree digit of the longitude.

6. A method for communicating geographical location comprising:
establishing a plurality of references, each having reference positional data and an identification (ID) code;
determining the geographical location (geo-location) of a mobile unit operating in a region;
receiving a compressed geo-location data of the mobile unit and a reference data of a reference covering said region; and
recovering the geo-location of the mobile unit by comparing the compressed geo-location data against a reference positional data, said reference positional data obtained from the received reference data.

7. A method of claim 6, wherein determining the geo-location of the mobile unit using a Global Position System.

8. A method of claim 6, wherein the compressed geo-location data is in units of latitude and longitude.

9. A method of claim 8, wherein the compressed geo-location data includes at most one least significant degree digit of the latitude and at most two least significant degree digits of the longitude.

10. A method of claim 9, wherein recovering the most significant degree digit of the latitude and at least the most significant degree digit of the longitude.

11. A cellular network comprising:
a plurality of cellular systems, each having reference positional data;
a mobile unit within a region covered by a cellular system, the mobile unit capable of determining the geographical location (geo-location) of the mobile unit; and
an application service provider (ASP) to receive compressed geo-location data of the mobile unit and to determine the geo-location of the mobile unit by comparing the compressed geo-location data against the reference positional data of the reference covering said region.

12. A network of claim 11, wherein the mobile unit determines the geo-location using a Global Position System.

13. A network of claim 11, wherein the compressed geo-location data is in units of latitude and longitude.

14. A network of claim 13, wherein the compressed geo-location data includes at most one least significant degree digit of the latitude and at most two least significant degree digits of the longitude.

15. A network of claim 14, wherein the ASP determines the most significant degree digit of the latitude and at least the most significant degree digit of the longitude.

16. A method for communicating geographical location in a cellular network comprising:
determining the geographical location (geo-location) of a mobile unit operating in a region;
receiving a compressed geo-location data of the mobile unit and an identification code corresponding to a cellular system covering said region;
recovering the geo-location of the mobile unit by comparing the compressed geo-location data against a reference positional data, said reference positional data obtained from the received identification code.

17. A method of claim 16, wherein the identification code is a system identification code of the cellular system covering said region.

18. A method of claim 16, wherein the identification code is one of a cell cite, a point code of a home location register, a point code of a visiting location register or a point code of a mobile switch center.

19. A method of claim 16, wherein determining the geo-location of the mobile unit using a Global Position System.

20. A method of claim 16, wherein the compressed geo-location data is in units of latitude and longitude.

21. A method of claim 20, wherein the compressed geo-location data includes one least significant degree digit of the latitude and at most two least significant degree digits of the longitude.

22. A method of claim 21, wherein recovering the most significant degree digit of the latitude and at least the most significant degree digit of the longitude.

23. A mobile asset tracking system comprising:
a plurality of geographical references, each having reference positional data;
a mobile asset installed with a mobile unit operating in a region covered by a geographical reference, the mobile unit to determine the geographical location (geo-location) of the mobile asset and to report a compressed geo-location data of the mobile asset; and
a locater to receive the compressed geo-location data of the mobile unit and to determine the geo-location of the mobile asset by comparing the compressed geo-location data against a reference positional data of the reference covering said region.

24. A system of claim 23, wherein the mobile unit determines the geo-location using a Global Position System.

25. A system of claim 23, wherein the compressed geo-location data is in units of latitude and longitude.

26. A system of claim 25, wherein the compressed geo-location data includes at most one least significant degree digit of the latitude and at most two least significant degree digits of the longitude.

27. A system of claim 26, wherein the locater determines the most significant degree digit of the latitude and at least the most significant degree digit of the longitude.

28. A system of claim 23, wherein the compressed geo-location data is transmitted through a cellular network.
